(19) United States
(12) Patent Application Publication
(10) Pub. No.: US 2009/0271257 A1
(43) Pub. Date: Oct. 29, 2009

(54) MODEL FOR EARLY ADOPTION AND RETENTION OF SOURCES OF FUNDING TO FINANCE AWARD PROGRAM

(75) Inventors: Gary W. Flake, Bellevue, WA (US); Nishant V. Dani, Redmond, WA (US); Brian James Utter, Seattle, WA (US); Alexander G. Gounares, Kirkland, WA (US); Kamal Jain, Bellevue, WA (US); Michael Conte, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/109,569

(22) Filed: Apr. 25, 2008

(51) Int. Cl. G06Q 30/00

(52) U.S. Cl. 705/14

(57) ABSTRACT

System(s) and method(s) are provided to drive early adoption and retention of disparate sources of funding and financing an award program, with application to a consumer compensation scheme subsidized through advertisement revenue. A component that manages advertisement revenue, or received funds, allocates a portion of revenue to subsidize a rebate program, or award program, for enrolled advertisers, or sources of funding, from a universe of advertisers. Rebate or award funds are provided to enrolled advertisers on an exclusivity based for a specific period of time, after which funds are transferred to a commonly accessible account. The subsidized nature of the awarded compensation funds and their time sensitivity drive advertiser enrollment and retention and ensures consumers are aggressively compensated. In an aspect, the subsidized rebate program can be exploited to directly compensate a consumer online or offline in exchange for the consumer's intent in engaging with a service platform.

### TECHNICAL FIELD

The subject specification relates to systems and methods for driving early adoption and retention of disparate sources of funding and financing an award program, with application to an advertisement-subsidized consumer compensation scheme.

### BACKGROUND

In conventional customer-service provider interaction, a customer or agent selects a service or goods provider based on an expectation that the provider would deliver relevant and competent service which would satisfy the needs of the agent. In addition, cost-benefit analysis generally contributes to the selection process, with the agent seeking the most value among available alternative. Once a selection is made—either a service provider is engaged in a commercial transaction, or a product is bought from a merchant—the agent conveys intent in accessing the service or utilizing a product. In response to the provided intent, an adequate selection of service provider or product generally leads to service or product satisfaction. In such a commercial paradigm, service providers and merchants typically compete for agent's intent by offering quality service and products while campaigning for brand recognition, awareness and loyalty, as well as service or product differentiation.

As part of efforts to attain brand recognition, awareness and loyalty, merchants generally rely on rebates. In addition, merchants that attempt to introduce a new product or service also resort to enticing prospective customers with promotional campaigns that offer monetary advantage (e.g., a free sample of a product/service, a discount, a rebate, . . . ). However, implementing a rebate program is typically costly and often the liquidity necessary to successfully implement a rebate or compensation campaign is difficult to sustain.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject innovation provides systems and methods to drive early adoption and retention of disparate sources of funding and financing an award program, with application to a consumer compensation scheme subsidized through advertisement revenue. A component that manages advertisement revenue allocates a portion of revenue to subsidize a rebate program for enrolled advertisers from a universe of advertisers. Rebate or compensation funds are provided to advertisers on an exclusivity based for a specific period of time, after which funds are transferred to a commonly accessible account. The subsidized nature of the awarded compensation funds and their time sensitivity drive advertisement enrollment and retention and ensures consumers are aggressively compensated. In an aspect, the subsidized rebate program can be exploited to directly compensate a consumer online or offline in exchange for the consumer's intent in engaging with a service platform.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIGS. 1A and 1B are, respectively, high-level block diagrams of an example system that promotes adoption and retention of disparate sources of funding and finances an award program, and an example system that sustains a rebate program and drives advertiser adoption and retention through compensation subsidies awarded to enrolled advertisers and funded through advertisement revenue in accordance with aspects described in the subject specification.

FIG. 2 illustrates example embodiments of an advertisement spend management component and a compensation component in accordance with aspects described herein.

FIGS. 3A, 3B and 3C illustrate, respectively, an allocation component, an intelligent component and a privacy component that provides various functionalities associated with compensation funds distribution in accordance with aspects described in the subject specification.

FIG. 4 illustrates an example system that compensates an agent through ad spend in exchange for the agent's intent in accordance with aspects disclosed in the subject specification.

FIG. 5 illustrates an example embodiment of an advertisement management component that facilitates management of ad spend and delivery of advertisement in accordance with aspects disclosed herein.

FIG. 6 presents a flowchart of an example method for driving advertiser early adoption and retention in accordance with aspects described herein.

FIG. 7 is a flowchart of an example method for allocating compensation funds according to aspects described in the subject specification.

FIG. 8 presents a flowchart of an example method for compensating an agent in exchange of the agent's commercial intent according to aspects set forth in the subject specification.

FIG. 9 presents a flowchart of an example method for compensating an agent through advertisement in exchange of agent's intent in transacting with a service platform in accordance with aspects described herein.

FIGS. 10 and 11 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

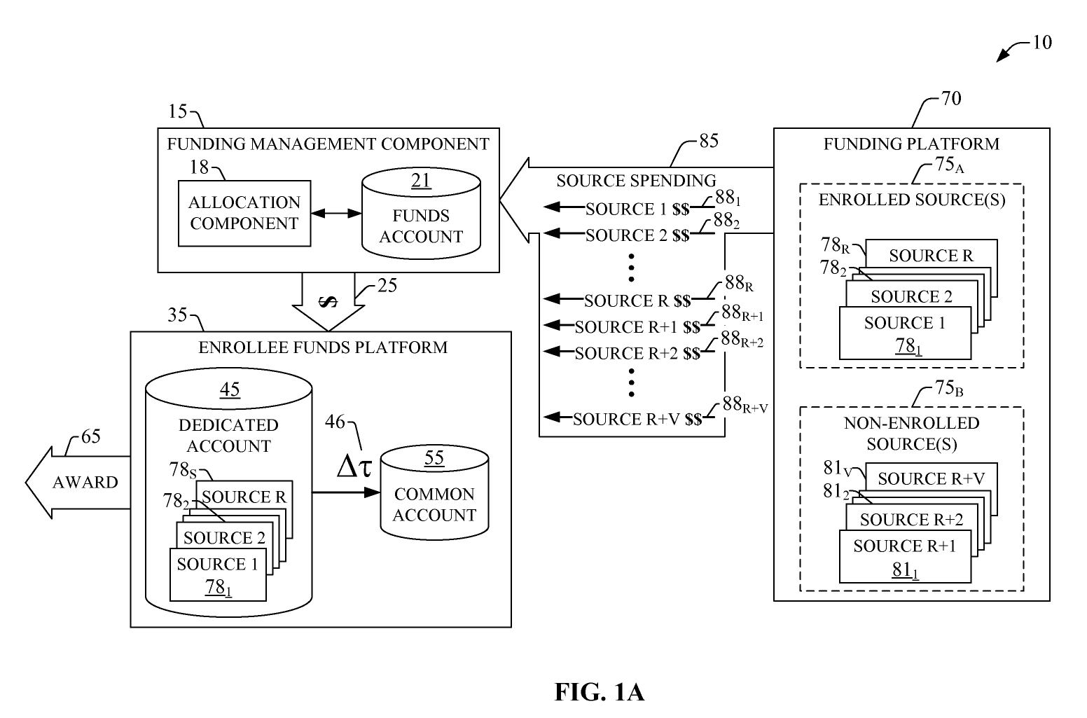

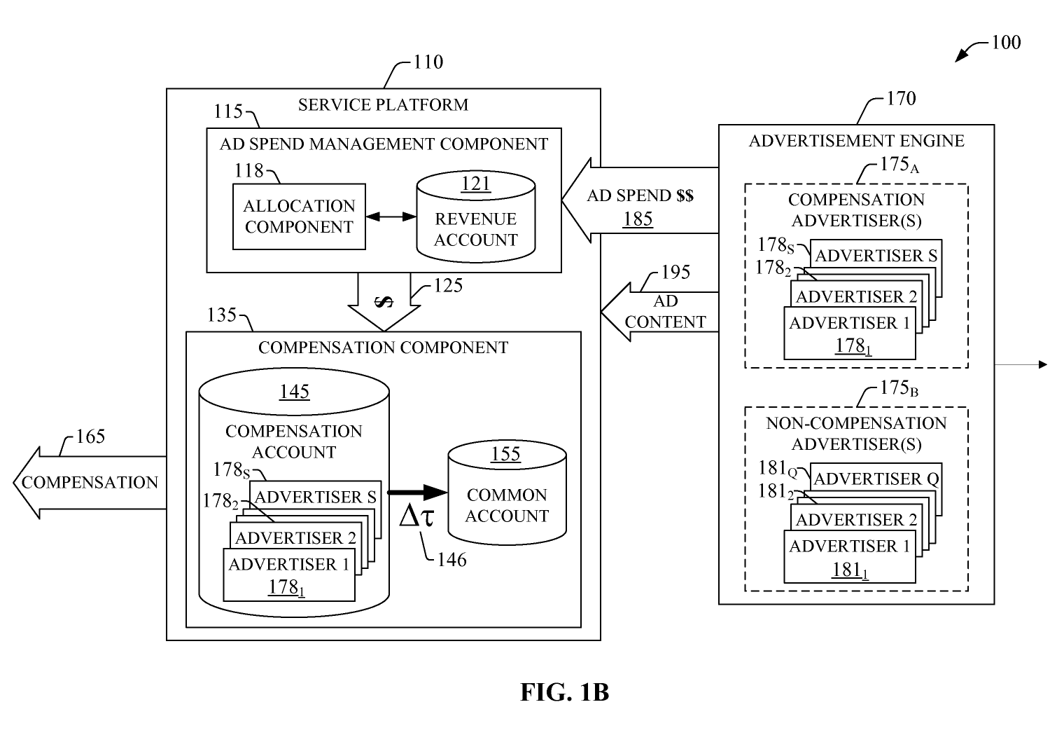

Referring initially to FIG. 1A, there is illustrated a high-level block diagram of an example system 10 that sustains an award program and drives adoption and retention of sources of funding through award subsidies to enrolled sources of funding, the award program financed through spending of the sources of funding. In example system 10, a component 15 that manages funding 85, comprised of funds 88₁-88_{R+V} received from a set disparate sources 78₁-78_{R} and 81₁-81_{V} (R, V positive integers) in a funding platform 70. All available funds are termed herein “source spending” 85. Funding management component 15 stores source spending in a funds account 21. It is to be noted that “funds” refers herein to substantially any good that is tradable, the goods are fungible or otherwise. Source spending 85 can be comprised of fungible and non-fungible goods. Trade associated with exchange of non-fungible goods can be mediated through an allocation component 18. For example, sources 88₁-88_{R+V} can be comprised of cash and other financials obligations (bonds, securities, etc), computer-based storage in a cloud server or mass storage, communication bandwidth, space for advertisement either on-line or offline, real state, digital and offline merchandise, and so on.

Additionally, allocation component 18 collects a portion of funds 25 stored in funds account 21, and allocates such portion of funds 125 to an enrollee funds platform 35 that affords enrollees 781-78R to provide award(s) as part of an award program. Awards can be provided in substantially any type of funds available to funding management component 15; for instance, an group for animal welfare can be awarded real state for a feline's sanctuary through the enrollee funds platform 35 as long as the funding platform 70 provides with spending in real state. Similarly, a food bank can received foods or coupons for food via enrollee funds platform 35. It is to be noted that once funds transferred to enrollee funds platform 35, enrolled sources 78₁-78_{S} can determine autonomously a mechanism to distribute available funds. For example, a supercomputer center that is enrolled to award funding according to aspects described herein, can determine that any applicant for computer time can receive time based on a competitive basis or an a first-come, first-served basis, or on an egalitarian system.

In an aspect, enrollment of a source of funding is effected through funding management component 15, through for example allocation component 18. Enrollment affords an opportunity to collects intelligence of the source of funding and to promote the award program and potential partnerships that can benefit awardees as well as grantors, or sources of funding.

In order to sustain an award program and entice adoption and retention, funds 125 are transferred to a dedicated account 45 that comprises award funds dedicated for exclusive utilization of enrolled sources 78₁-78_{S}. It is to be noted that all sources of funding 88₁-88_{R+S} generate the funds 125 that sustain the award program implemented by enrolled sources 88₁-88_{S}; in other words, a set of source of funding employ funds from an entire universe of funding sources. Thus the subsidized award program promotes adoption by sources of funding the benefits of accessing subsidies for award(s) 65 generally outweighs investment typically necessary for implementation of an award program. In addition, as the entire universe of sources of funding finances the award program, sources of funding that aim at establishing an award program are thus enticed to adopt the award scheme implemented via funding management component 15 in order to avoid a scenario in which a competitor source of funding provides awards (which typically increases reputation for non-for-profit organizations, elevating profile thereof and their ability to effect positive change; or in the case of for-profit organization facilitate market share gains, mitigates consumer attrition and so on) through source funding 85 contributed by the non-enrolled sources of funding. Thus, example system 10 for implementing awards possesses at least the following advantages. (a) The system 10 is an attractor of new sources of funding and intrinsically mitigates advertiser attrition, and (b) favors early adoption over late adoption, since a substantially higher share of subsidies are available to enrolled advertisers.

To ensure, in a non-regulatory manner, award 65 is passed on to an awardee rather than withheld by a source of funding, unused compensation funds in exclusive accounts are transferred to a common account 55 after a specific period of time Δτ 46. In an aspect, a policy established by enrollee funds platform 35 determines the time period 46. It should be appreciated that such time period can be adjusted as a function of time according to the policy. Funds in the common account are accessible to substantially all enrolled advertisers, and unlocking mechanism(s) of funds in common account 55 can be based at least in part on a policy or a market mechanism. An advantage of the latter transfer cycle is at least that it acts as an instrument to drive enrolled sources of funding to aggressively issue awards because unused funds of enrolled sources of funding that withhold awards or are not appealing to prospective awardees are likely to be utilized by a competitor source of funding that has exhausted its dedicated award funds. It is to be noted that advertisers that are early adopters continue to benefit from compensation subsidies in the common account 55, since the low number of enrolled advertiser allows substantive rewards to be awarded to consumers.

It is to be noted, that in an aspect, transfer time period Δτ 46 can be determined by a transfer policy established by funding management component 15. In particular, time period 46 can be distributed according to sources of funding interest(s) and specific objectives. Policy can be based at least in part on longevity of source of funding on the award program, reputation and impact of the source of funding among awardees, and so on.

It should be appreciated that the foregoing compensation program maintains an equilibrium with respect to adoption strategies of advertisers. In particular, the equilibrium benefits early adopters. It is to be noted that the award program drives adoption by sources of funding until the magnitude of available awards ceases to be attractive so as to promote further enrollment. Once equilibrium has been reached, with respect to enrolled source of funding and potential compensation quality, it is sustained since exit of sources of funding from the award program results in increased funds available for issuing award(s), therefore the award program becomes increasingly appealing to non-enrolled sources of funding. Once new sources of funding are attracted the flow of enrollment ceases once a new equilibrium is reached.

In addition, funding management component 15 can influence the equilibrium conditions of the subsidized award program by increasing the P % of source spending 85 that is devoted to funding awards, or it can inject external funds for specific purposes at specific times. Injection of external funds can be utilized to eject poor-quality sources of funding, by favoring disparate sources of funding with superior quality of awards (e.g., more relevant research, or social programs, or better products such as armored vehicles or hybrid cars) through injection of funds in the funding accounts of such quality sources of funding.

It should be appreciated that funding management component 15 and enrollee platform 35 can be a part of a service platform, which can pursue for-profit activities, or it can be a non-for-profit or philanthropic organization. For example an organization that fund basic research (e.g., National Science Foundation, or National Institutes of Health) can employ the innovation herein to facilitate donors to exceed target quotas of donation towards research.

In turn, FIG. 1B, illustrates a high-level block diagram of an example system 100 that sustains a rebate program and drives advertiser adoption and retention through compensation subsidies awarded to enrolled advertisers and funded through advertisement revenue. In illustrative system 100, a service platform 110 includes a component 115 that manages advertisement spend 185 received from an advertisement engine 170, which comprises for example a universe of S+Q advertisers (S and Q positive integers) 175_{A} and 175_{B}. Ad spend management component 115 stores advertisement revenue in a revenue account 121. It is to be noted that advertisement revenue is generated by the ad spend 185 of the universe of advertisers engaged in commercial transaction(s) with service platform 110. An allocation component 118 the resides in ad spend management 115 collects a portion, e.g., a P percentage, of revenue stored in revenue account 121, and allocates such portion of revenue, or funds 125, to a compensation component 135 that awards compensation 165 as part of a subsidized rebate program of service platform 110. Initially, funds 125, e.g., P percentage of advertisement revenue, are transferred to a compensation account 145 that comprises compensation funds dedicated exclusively to a set of advertisers 178₁-178_{S} enrolled in the subsidized rebate program. It is to be noted that the entire universe of advertisers, e.g., compensation advertisers 175_{A} and non-compensation advertisers 175_{B} generate the portion advertisement revenue, funds 125, direct to sustain an rebate program for a set of advertisers within the entire universe of advertisers. Advertisers are part of an advertisement engine 170, which in an aspect can be a part of a merchant which utilizes service platform 110 as an advertisement service or broker. In another aspect, advertisement engine 170 can be an advertisement intermediary between service platform 110 and a set of disparate merchants. In yet another aspect, advertisement engine 170 can be an integral part of, and managed by, service platform 110.

The subsidized compensation program promotes advertisement adoption of a rebate campaign since the benefits of accessing subsidies for compensation generally outweighs difficulties generally associated with implementation of a rebate program. In addition, as the entire universe of advertisers effectively funds the rebate program, advertisers are enticed to adopt the rebate program to avoid a scenario in which a competitor advertiser of an non-compensation advertiser awards rebates through ad spend contributed by the non-compensation advertiser.

As discussed above, to ensure, in a non-regulatory manner, that compensation 165 is passed on to a consumer rather than withheld by an advertiser, unused compensation funds in exclusive accounts are transferred to a common account 155 after a specific period of time Δτ 146. In an aspect, a policy established by service platform 110 determines the time period 146. It should be appreciated that such time period can be adjusted as a function of time according to the policy. Funds in the common account are accessible to substantially all enrolled advertisers, and unlocking mechanism(s) of funds in common account 155 can be based at least in part on a policy or a market mechanism such as highest bidder, supply-and-demand, bonds and securities issued against unsued funds and traded among registered advertisers, and so on. An advantage of the latter transfer cycle is at least that it acts as an instrument to drive enrolled advertisers to aggressively compensate consumers because unused funds of enrolled advertisers that withhold rebates are likely to be utilized by a competitor advertiser that has exhausted its dedicated compensation funds. Therefore, aggressive compensation is intrinsically sustained within an advertisement funded rebate program. It is to be noted that advertisers that are early adopters continue to benefit from compensation subsidies in the common account 155, since the low number of enrolled advertiser allows substantive rewards to be awarded to consumers.

In addition, similarly to system 10, Δτ 146 can be determined by a transfer policy established by ad spend management component 115. In particular, time period 146 can be distributed according to advertiser segments defined by contracted volume of advertisement, longevity of advertiser in the compensation-stimulated advertisement program, market segment targeted by advertiser, reputation of advertiser among consumers, and so on.

It should be appreciated that the foregoing compensation program maintains similar equilibrium properties as discussed above in connection with system 10. It should be appreciated that the presence of such an equilibrium drives advertiser strategies for enrollment. It is to be noted that from a game-theoretic perspective the rebate system offer incomplete information, and systematically poses a Prisoners' Dilemma to non-enrolled advertisement.

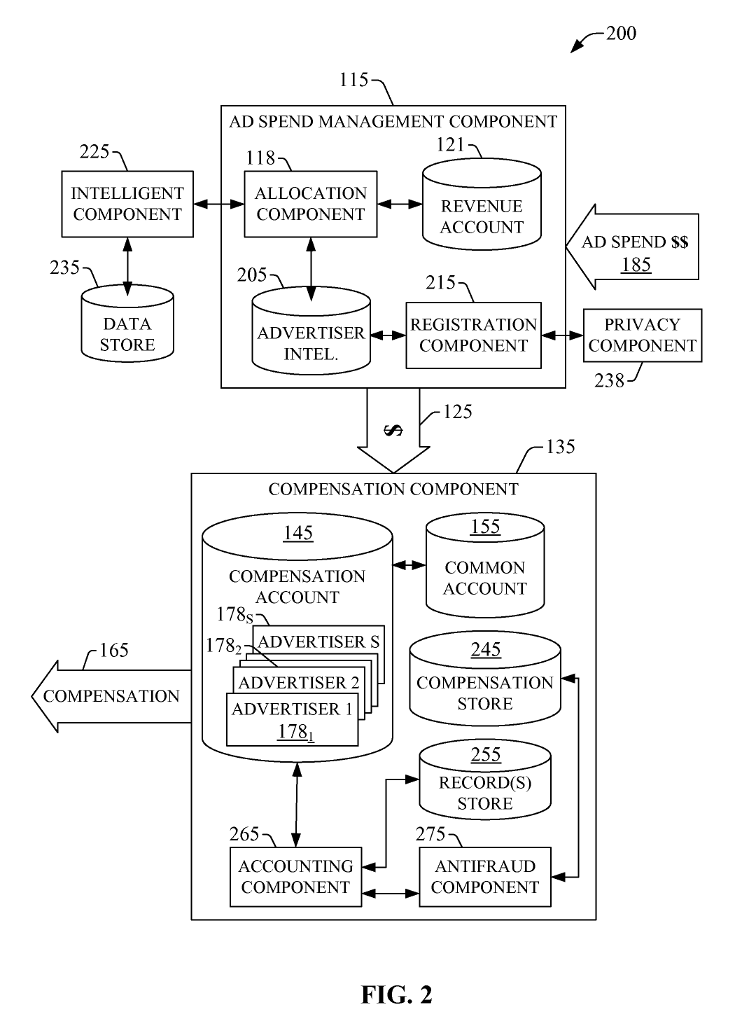

FIG. 2 illustrates an example embodiment 200 of advertisement spend management component 115 and compensation component 135. In embodiment 200, ad spend management component 115 includes an allocation component 118 and revenue account 121. In addition, a registration component 215 enrolls advertisers to participate in the subsidized compensation program. Advertiser information is collected according to privacy regulation enacted by a privacy component 238 and the collected information during registration is stored as advertiser intelligence 205. In addition, allocation component can rely on intelligent component 225 and advertiser intelligence 205 to infer a level of advertisement revenue funds 125 to direct for compensation, a transfer cycle period 146, and the magnitude and times at which external funds are to be injected to attain determined dynamics among advertisers. Such dynamics can be based on optimization of utility for service platform 110, a specific advertiser, or a specific consumer segment; to promote a specific product; to boost adoption; and so on. In addition, intelligent component 225 can utilize supplemental data stored in memory 235 to facilitate the accomplishment of the foregoing. Supplemental data can include data from experiment(s) and simulation(s) on advertiser behavior. Moreover, supplemental data can include data generated by intelligent component 225.

In embodiment 200, compensation component 135 comprises compensation account 145 and common account 155; funds can be transferred from the former to the latter in transfer cycles as described above. Specific compensation can be stored in compensation store 245. It is to be noted that compensation 165 made available through component 135 typically has monetary value; thus, to ensure compensation is adequately awarded, accounted for, and recorded, compensation component 135 includes an accounting component 265, an antifraud component 275, and a records store 255.

Compensation store 245 operates, in an aspect, as a container for available compensation and rewards. For compensation to be delivered online, digital content utilized to compensate an agent 410 can be stored in compensation store 245. For compensation that is to be delivered or awarded offline, a digital token (e.g., a cookie file, an encryption key, . . . ) can be stored in memory 245. An advantage of compensation store is that contents from disparate advertisers, many of which can be competitors can be stored on a same container and thus centralize compensation distribution.

Accounting component 265 can account for payments, retain compensation records in record(s) store 255, and monitor a current level of compensation to ensure, for example, compensation fails to surpass a compensation limit established by an advertiser that issues the compensation. In an aspect, when compensation issued by an advertiser are points (e.g., generic points, reward point, or platform specific points lime Microsoft® Points), accounting component 265 can conduct the accounting thereof. In addition, compensation event(s) can be recorded by accounting component 265. Generally, compensation records can include type and amount of compensation delivered and can augment available intelligence on agent 110. Retaining records of delivered compensation facilitates to resolve disputes that can arise from fraudulently awarded compensation. In a dispute, service platform 110 can start an audit of a reward transaction to confirm its veracity.

Antifraud component 275 manages security features that mitigate fraudulent exploitation of compensation and preserve compensation records integrity. Antifraud component can exploit various resources such as advertiser intelligence 205, data stored in memory 235, intelligent component 225, and so forth. Moreover, antifraud component 275 can implement detection of biometric markers (e.g., voice signature, face-feature recognition like recognition of scars, moles, freckles, eye color and iris structure, and so on) in online and offline compensation that can facilitate biometric-based verification to ensure that an intended customer indeed received an intended compensation. Antifraud component 275 can provide substantially all functionality associated with probing biometric features (e.g., cameras for bio-feature recognition, fingerprint pads, iris scanners . . . ), encrypting/decrypting online compensation, etc; yet, utilization of resources available to other system components can also be exploited. In an aspect, antifraud component 275 can mitigate fraudulent compensation by systematically reducing the face-value of delivered compensation for reiterative engagements with an enrolled advertiser (e.g., advertiser 178_{S}) that is determined, for example via intelligent component 225, to be likely fraudulent. A characteristic relaxation time for compensation value can be determined by antifraud component in conjunction with an enrolled advertiser, for example, according the degree of confidence on the illegitimate nature of substantially any transaction with the enrolled advertiser that leads to a rebate.

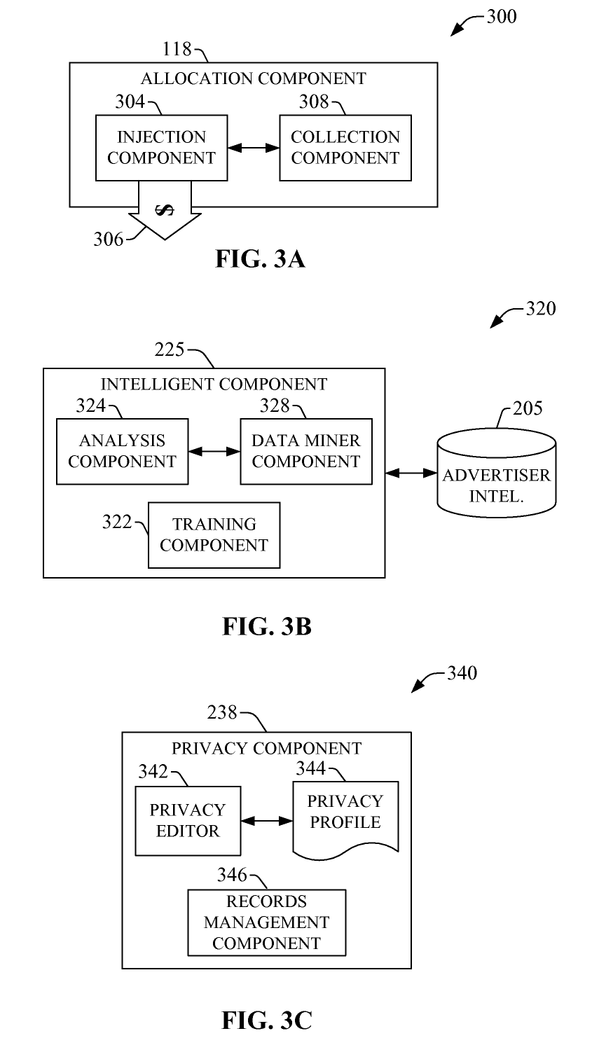

FIG. 3A is a block diagram 300 of an example allocation component that distributes a portion of advertisement revenues to a compensation component and injects funds therein. In embodiment 300, allocation component 118 further drives the adoption and retention of compensation-stimulated advertisement through injection of external funds 306, which need not arise from advertisement revenue, to further subsidize specific commercial endeavors or usage of an advertiser (e.g., advertiser 178₂) such as compensation of a specific market segment, implementation of a sweepstakes or lottery contest(s), delivery of high-end compensation, advertisement in alternative media or via non-traditional technologies (e.g., holography, bio-implanted devices, and the like). In addition, allocation component 118 comprises a collection component 308 that transfers funds within an exclusive or dedicated advertiser's compensation account to a commonly accessible compensation account, e.g., common account 155. As discussed above, transfer takes place at specific times dictated by a financial policy (e.g., which can be stored in memory 235) established by advertisement spend management component 115.

FIG. 3B illustrates an example embodiment 320 of intelligent component 225 that can reason or draw conclusions about the intent of an agent to engage or utilize a service platform (e.g., service platform 110) based at least in part on available information on the agent, advertiser intelligence (e.g., advertiser's information in storage 205), and supplemental data 235 available to ad spend management component 115. Intelligent component 225 can generate a probability distribution of specific states of agent's intent in engaging in a transaction with service platform 120 without human intervention. To infer compensation funding 125 and externally injected funding, intelligent component 225 relies on artificial intelligence techniques, which apply advanced mathematical algorithms—e.g., decision trees, neural networks, regression analysis, principal component analysis (PCA) for feature and pattern extraction, cluster analysis, genetic algorithm, and reinforced learning—to a set of available (as it can be determined by privacy component 238) information associated with advertisers 175_{A} and 175_{B}.

In particular, the intelligent component 225 can employ one of numerous methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Analysis component 324 can execute at least a portion of the algorithms cited above for inferring, for example, suitable fractions of advertisement revenue to be directed towards compensation. Data miner 328 can further support analysis of information (e.g., advertiser intelligence 205) through data segmentation, model development for simulation(s) of advertiser behavior and related model evaluation(s). It is to be noted that additional algorithm and computational resources can reside in analysis component 324, such as Monte Carlo simulations, game theoretic models (game trees, game matrices, pure and mixed strategies, utility algorithms, Nash equilibria, evolutionary game theory, etc.) of advertiser behavior, magnitude of compensation subsidies and injected external funds, and so on. Data miner 608 can further support analysis of information through data segmentation, model development for agent's behavior simulation(s) and related model evaluation(s) (e.g., generation of lift charts for discrete and continuous variables). Training component 322 utilizes available market and advertiser data or intelligence for various machine learning approaches. As available information increases, training results in improved performance of intelligence component 225 and component that utilize it.

It should be appreciated that empirical approaches can also be utilized by intelligent component in order to determine whether agent's intent is aligned with a compensation 165. Empirical approaches are commonly “a posteriori” methods in that an association among compensation and intent adequacy is determined upon a measured response of a compensated agent. Such information can then be utilized to compensate forthcoming agents. Empirical approaches are typically appropriate for scenarios in which a privacy setting or profile is stringent and minimal intelligence on the consumer can be extracted directly from the consumer. In addition, empirical approaches are generally simple and present an intrinsically low implementation threshold.

It is to be noted that the approaches to associate intent with suitable compensation can be implemented at the service-platform level or at the advertisement engine level. In the latter case, an advertiser 175A typically determines metrics and policies for compensation-intent association and delivery. In an aspect, such policies can adhere to compensation planning, e.g., objective, policy, content, audience, established by service platform 110.

FIG. 3C illustrates an example embodiment 340 of privacy component 238 which can be utilized to regulate registration process effected by registration component 215. Privacy component 238 can comprise a privacy editor 342 which facilitates establishing a privacy profile 344. Privacy editor 342 can exploit a graphical user interface (not shown) to facilitate an advertiser (e.g., advertiser 178_{S}) to opt for a predetermined level of privacy with respect to the information that can be collected. It is to be appreciated that privacy editor 342 can be provided through a webpage maintained by a service platform 430. It should be appreciated that privacy editor 342 can be accessed asynchronously and as often as an advertiser desires. Privacy profile 344 can be encrypted to further ensure privacy integrity. Privacy component 238 also manages how records of collected information related to an advertiser are stored within advertiser intelligence store 205.

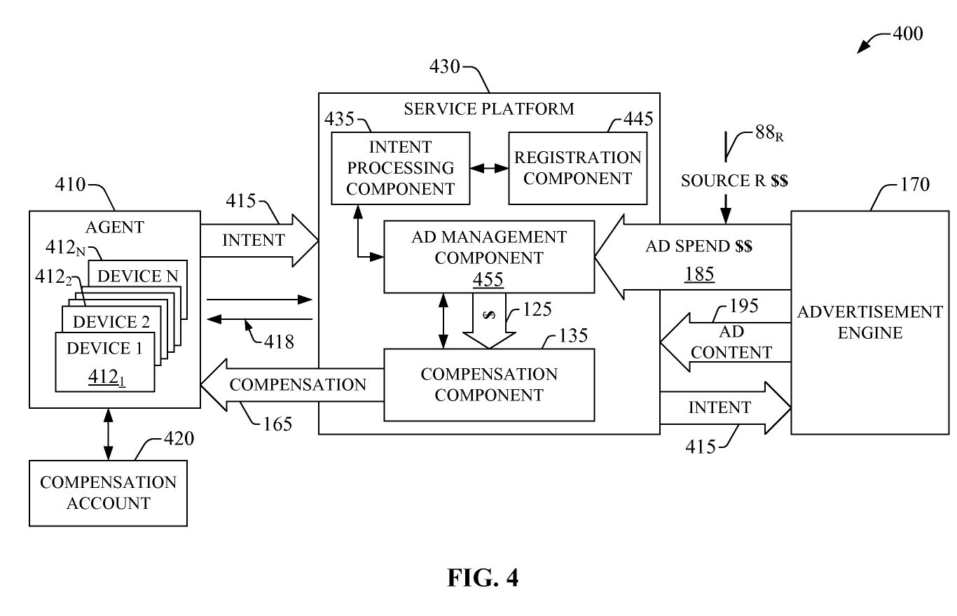

FIG. 4 illustrates an example system 400 that compensates an agent through ad spend in exchange for the agent's intent in accordance with aspects disclosed in the subject specification. In example system 400, agent 410 conveys a commercial intent 415 to a service platform 430, which compensates agent 410, via compensation 165, in return for the agent's conveyed intent 415. It should be appreciated that while a single agent 410 is illustrated, multiple customers can be included in agent 410. It is to be further appreciated that the commercial nature of agent's intent 415 lies in the fact that the intent 415 reveals the underlying purpose (e.g., purchasing a merchandise, selecting or subscribing to a service or product, utilizing a software application, requesting/accessing for specialized advise, and so on) of accessing service platform 430 and constitutes a key to receiving service from it—Agent 410 discloses intent 415 based on an expectation that the service platform 430 may be relevant to the agent's needs. By effecting such compensation, service platform 430 creates a monetary differential in favor of the customer, e.g., a user price incentive, and can distinguish itself from competitors. Such a distinction can occur at different levels: brand recognition, service/product demand, engagement of early adopters, potential for formation of business partnerships, and so on.

Service platform 430 is neither limited to a specific industry nor a specific service. Additionally, industry or service is neither limited services consumed online (e.g., through the Internet) nor offline (e.g., access to the service does not hinges on access to the Internet). A desirable characteristic of a service, or product obtained through service platform, is that the service is primarily accessed regularly (e.g., on a daily basis). Agent's intent 415 and the service provided, or goods delivered, by service platform 430 typically are interdependent. Online service platform.—In an aspect, service platform 120 can be an online search engine, wherein the search query embodies the agent's intent in receiving a list of search results. Moreover, customer intent 115 can be related to searching for a provider or particular goods or services, and a plurality of providers may compete for knowledge of such intent (e.g., by offering rewards/incentives) in order to be presented to the customer in a favorable forum/light that will facilitate a commercial transaction transpiring between the customer and the service or product provider. In another aspect, service platform 120 can be an online portal of a technical journal, where an agent looking to retrieve a specific article provides a citation to the article (e.g., intent 415) and the publisher responds by presenting or delivering the article to the user. In another aspect, service platform 430 can be an online software application service wherein an interface customized for an agent provides the functionalities of a specific software application (e.g., payroll and benefits applications; business development and program management applications, simulation applications; online gaming applications; and so on) for a service fee. In yet another embodiment, service platform 430 can be social networking website, wherein the service platform facilitates (i) customer expression through deployment and maintenance service(s) of a webpage, and (ii) interactions among disparate customers. It should be appreciated that various additional online services can be contemplated.

Offline service platform.—Substantially any merchant or service provider that operates offline can adopt the intent-compensation paradigm described herein; for instance, car and motorcycle dealers, department stores, coffee shops, liquor stores, bookstores, and so on.

Agent 410 can utilize various devices 412₁-412_{N}, which can either be wired or wireless (e.g., a cell phone, a laptop, tethered computer, vehicular navigation device, game console, or personal digital assistant) and with a display area that can be accessed interactively or otherwise, to convey intent 415. Based at least on disclosed information, the conveyed agent's intent 415 can be classified in at least two broad categories: (a) explicit expression of intent, and (b) implicit expression of intent. To convey intent and participate in the intent-compensation commercial scheme established in example system 400, an agent registers with system platform 430 through registration component 445, which gathers agent intelligence during the registration process. In addition, the agent also registers the set of devices 412₁-412_{N}. Registration of devices 412₁-412_{N} facilitates delivery of compensation and customized information related therewith such as advertisement, compensation opportunities, merchants affiliated with service platform 430 that participate in the intent-compensation commercial model, and so on. In addition to the benefits for the user in connection with participating in the intent-compensation price incentive model of service platform 430, registration with service platform 430 is also advantageous as agent intelligence can be collected at the time of registration, and utilized by service platform 430, for example, for targeted marketing campaigns.

Service platform 430 also includes an intent processing component 435 that obtains agent's intent 415 through a variety of instruments or mechanisms (e.g., portals, pop-up windows, queries, statements, utterances, inferences, extrinsic evidence, historical data, machine learning systems, webcams, charge-coupled device (CCD) cameras, microphones, feature harvesting systems, and so forth). Intent processing component 435 can evaluate the veracity of the agent intent 115 and generate confidence metrics associated therewith. Such confidence metrics can be factored in connection with allocation of compensation 165. It should be appreciated that, unlike conventional couponing and rebate schemes, intent processing component 435 determines or infers customer intent dynamically (for example via Internet or wireless communications—e.g., search engines and cellular telephones are examples of platforms suitable to deploy various embodiments described herein), and utilizes the determined intent to facilitate joining the agent with advertisers and, alternatively or additionally, suitable service providers (not shown) affiliated with service platform 430 in connection with maximizing utility to the user or the service provider. In addition, intent processing component 435 provides agent 410 with bargaining power through solicitation of intent information (the solicitation can occur through a wireless, wired, or hybrid communication link 418) which conventionally was often provided for free by an agent (e.g., agent 410). As a result, agents can increase buying power or wealth through leveraging off the value of their respective intent information. Furthermore, a filtering process can be achieved where unmotivated service providers or merchants, or respective advertiser, are not exposed to the agents thereby mitigating spam-like solicitations. An embodiment for intent processing component is discussed below.

In illustrative system 400, intent processing component 435 receives intent 415 from an agent 410. Intent 415 can be gleaned from information received from agent 410 in connection with a commercial intention in engaging a service platform 430 (e.g., a merchant, a service provider, or a content provider). Information is typically received by intent processing component 435 through communication link 418. As indicated above, communication link 418 can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. In addition, information can be intrinsic, e.g., conveyed by agent 410, or extrinsic, wherein intent processing component 435 collects information associated with agent 410 actions with respect to a service platform (e.g., service platform 430). To collect information, intent processing component 435 can exploit a variety of instruments and devices such as web cameras, infrared-visible cameras, CCD cameras sensitive to specific radiation frequencies, microphones, biometric pads, physiological sensors, positioning systems (e.g., Global Positioning System (GPS), Galileo, GLONASS), and associated wired and wireless transceivers that can communicate the gathered information.

To ensure privacy integrity of an agent's actions, a privacy component 238 regulates the information that can be collected to extract agent's intent. Agent 410 can establish a privacy profile, or privacy settings, in substantially the same manner as it has been described above in connection with an advertiser. Privacy component 238 also manages how records of collected agent's actions are stored within an agent intelligence store (not shown) or substantially any memory available to service platform 430.

Collected information compatible with privacy regulations, or policies, can be utilized by intent processing component 435 to infer agent's intent 415 through, for example intelligent component 225. Analysis and feature or pattern mining of information can be implemented by intelligent component 225 to extract agent's intent.

In an aspect, compensation 165 can be provided through advertisement; e.g., subsidized through advertisement revenues that result from ad spend 185, and offered via ad content 195 generated by advertisement engine 170. In addition, other sources of funding can be received from like source R 88_{R}, which can afford a disparate tradable fund of interest to specific segments of customers of advertisers in advertisement engine 170. Compensation of an agent (e.g., agent 410) through a direct payment or an allocation of reward points can be delivered (via communication link 418) to a compensation account 420 that belongs to the agent. Service platform 430 includes an advertisement management component 455 that utilizes a known (through explicit intent expression) or established (e.g., extracted from an implicit expression) agent's intent 415 to generate advertisement impressions that carry a compensation in exchange of the customer intent. Compensation can be accessed through advertisement in multiple manners, or advertisement models or mechanisms to unlock, accrue, and/or deliver compensation: (1) Advertisement exposure. In this scenario, the advertisement impression is conveyed to the user in the form of direct compensation, wherein the advertisement is a “conduit” for delivering the compensation. (2) Advertisement instantiation. A compensation is received by instantiating the advertisement impression; e.g., by following instructions in the advertisement such as for example, responding to an online or telephonic survey; visiting an online webpage or an offline showroom, watching a movie trailer or portion of a movie soundtrack, and so on. It is to be appreciated that instantiation need not entail a commercial transaction with neither an advertiser not service platform. (3) Advertisement-driven action. Compensation is the result of a specific commercial transaction between the agent that conveys intent and the advertiser. It is to be appreciated that intent-driven advertisement is intrinsically targeted, thus the likelihood of an agent engaging in a transaction with the advertiser or service platform is substantially high. The likelihood of an agent take action can be biased via the level of provided compensation; namely, advertisement management component 455 can present advertisement that offer a compensation that is above a known or inferred engagement threshold associated with the agent that conveys the intent 415. It is to be noted that since this model to unlock compensation entails an action from an agent, it provides an opportunity to gather agent (e.g., agent 410) intelligent with respect to the type of commercial transaction that is enacted; namely, intelligence can include a time elapsed since agent first conveyed intent 415, either explicitly or implicitly, until advertisement-driven action is taken, the latter can be a measure of advertiser performance and can be measured or processed, in an aspect, by advertisement management component 455; various responses of agent to ad-driven action advertisement; and so on. In an aspect, this mode for accessing compensation can supplement (1) or (2).

It should be appreciated that compensation-unlock models (1)-(3) can have disparate advantages with respect to service platform 430 and an advertiser in advertisement engine 170. With respect to advertisement-exposure unlock mechanism, such a model can substantially increase agent 410 utilization of service platform 430; thus, such model is advantageous for the service platform, and can facilitate meeting traffic objectives and other utilities associated with service platform operation. Unlock model (2) affords shared advantages among service platform and an advertiser, since instantiation demands a moderate degree of activity from the agent, yet it does not require a commercial transaction to be enacted with the advertiser to accrue compensation, utilization of service platform is increased and exposure to an advertiser is incremented as well. Unlock model (3), advertisement-driven action, is advantageous for an advertiser, as compensation 165 is unlocked upon an actual, typically monetary transaction between agent and advertiser.

As discussed above, to finance compensation (e.g., compensation 165) to a customer (e.g., agent 410) in exchange for the customer's intent (e.g., intent 415), service platform 430, through ad management component 455, can direct funding 125 arising from advertisement revenue to compensation component 135. The amount of funding 125 directed towards compensation is typically determined according to a financial, game-theoretic model that ensures a zero-sum scenario with respect to (a) advertisement revenue and external funds directed towards compensation; (b) ad spend 185 for advertisement campaigns; and (c) credit awarded for advertising to advertisement engine 180 by service platform 120 over an advertisement cycle (e.g., a week, a month, a quarter, . . . ). It is to be noted that (c) can be viewed as funds that “prime the pump” for an advertisement engine 180, by providing subsidies for advertisement campaigns in emerging markets; focused on new products or services; or based on new advertising techniques, resources and media. In addition, advertisement credits also facilitate exposure of advertisers to the subsidized-compensation commercial model without an upfront financial commitment. The latter can facilitate early adoption.

Once an advertisement model, or instrument, for compensation delivery is selected; based at least in part on the nature—explicit or implicit expression—of the intent 415 received by service platform 430, the available intelligence on the originating agent, etc.; and consistent action has been taken by a customer (e.g., agent 410), compensation component 135 delivers compensation 165. To that end, as discussed above, compensation component 135 performs multiple tasks, which comprise accounting, managing fraud, and retaining records associated with compensation. In an aspect, compensation component 135 can manage issued compensation like adopting changes to face-value of compensation 165; for instance, conferring a promotional value, typically above average or generally awarded value, to the compensation 165 if specific actions are taken by an agent like responding to an online product survey or visiting an offline store show-room within a specific period of time. In another aspect, compensation component 135 can determine specific compensation according to agent intelligence available to service platform 430, in order to mitigate customer attrition, or increase the quality of information associated with intent (e.g., increase the instances in which intent is conveyed via explicit rather than implicit expression). In yet another aspect, compensation component 135 can broker partnerships with disparate online or offline merchants that may be affiliated with service platform 430.

It is to be appreciated that through a set of registered mobile devices (e.g., devices 412₁-412_{N}), compensation component 135 can provide compensation either online or offline. Registration of devices that can receive compensation facilitates the optimization of a device's resources when conveying an advertisement that carries compensation. Furthermore, a set of devices that are utilized at the time an eligible action is undertaken by agent 410 can drive the compensation type. For example, agent 410 utilizes an online service to trade stocks (a possible embodiment of service platform 430) in a laptop computer (e.g., device 412₁) while the agent 410 listens to music in a Zune® digital media player—that agent 410 is listening music in a Zune® device (e.g., device 412_{N}) can be gleaned from information collected by webcam operating on the agent's laptop computer and conveyed to intent processing component 435—at a specific instance agent 410 buys stock from an entertainment company. The system platform, based on the transaction, available intelligence about the user, and the fact that the user is listening to a Zune® device, result in a digital song delivered to the user email inbox (and possibly a notification to the agent's cell phone) as a compensation for conveying intent to the stock trading system. The illustrative scenario described hereinbefore displays a central advantage of the intent-compensation price incentive scheme herein disclosed with respect to conventional system: Compensation can be synergistically customized based on context and behavior, rather than established solely on user intelligence or eligible action.

As illustrated above, compensation 165 has monetary value. Monetary value can be effected (i) directly, e.g., monies are deposited in a compensation account (not shown in FIG. 1) that belongs to agent 410, or debt carried by agent 410 in, for example, credit card(s) is reduced by a specific amount—it should be appreciated that such credit card(s) can be issued or managed by service platform 430 or an affiliated lender (e.g., service provider) which makes debt reduction substantially more affordable and advantageous to the service platform 430. Direct payments can be electronic and effected in real time, via a wireless transmission effected through communication 418 directly to a debit/credit card registered by agent 410. The magnitude of a direct payment awarded to agent 410, as compensation 165, is generally a function of multiple variables: enrollment longevity, income bracket, educational level, professional activities, leisure activities, and demographics factors. Based at least in part on such parameters, compensation component 135 can determine an adequate compensation for agent 410. It is to be appreciated that agent 410 can be notified to one or more of the agent's registered devices that a direct payment incentive has been awarded; for example, in an online interaction a user can receive an instant message describing the type and magnitude of the compensation, or in an offline interaction the user can receive a short message service (SMS) message to the agent's cell phone, pager, or any other registered device (e.g., device 412₁-412_{N}).

Monetary value can also be effected (ii) indirectly, such as through reward points, service-specific points, platform-specific points, virtual monies or points, e.g., Microsoft® Points or substantially any other denomination, that can be used to claim a rewards either online or offline. In addition, agent 410 can be compensated with generic points (or substantially any other tokens associated with materializing a compensation) that facilitate claiming products or merchandise of different types and scope. Points, generic or otherwise, can be perishable or perennial, and can be transferred to a second agent (not shown). It should be appreciated that, in an aspect, generic points can be managed dynamically by service platform 430, adopting promotional value to drive a specific product or service campaign, or changing scope as a function of the point bearer (e.g., a compensated agent like agent 410). An alternative or additional form of indirect monetary compensation can be effected through digital merchandise like songs; ring-tones; movies; pictures; books; magazine articles, technical or otherwise; greetings cards; games, console-based and online, single-player or multiplayer; software application add-ons such as Microsoft® Visio® stencils or custom font sets; foreign-language dictionaries; maps, secret passages, and answers to riddles for second worlds relevant to role playing games, and so on.

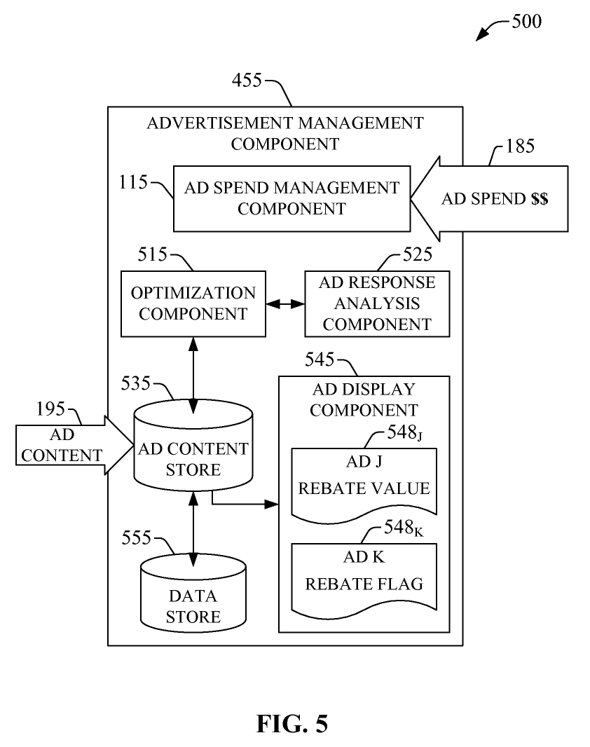

FIG. 5 illustrates an example embodiment of an advertisement management component 145 that facilitates management of ad spend and delivery of advertisement in accordance with an advertised based intent-compensation consumer incentive scheme. Illustrative component 455 comprises an ad spend management component 115 that receives and manages advertisement spending 185 from advertisement engine 170. As discussed above, a portion of revenue 125 that results from ad spend 185 is directed to subsidize compensation accounts, e.g., advertiser compensation account 145 and common account 155. In an aspect, compensation funds 125 administered by ad spend management component 115 can be utilized to compensate an agent in exchange for the agent's intent in engaging in a transaction with service platform 430. Advertisement management component 455 also includes an optimization component 515 that (i) adjusts advertisement content delivered to an agent, and (ii) optimizes advertisement format in accordance with a registered device utilized by the agent. It is to be appreciated that optimization of advertisement format for according to the media resources of a particular device (e.g. a device with limited display real state, or a device with limited sound capabilities such as a navigation system) provides the agent with a richest advertisement experience available to the device and thus increases the likelihood that the agent responds to the advertisement.

Optimization of advertisement format and delivery, via optimization component 515, can rely on input provided by ad response analysis component 525, which can monitor response metrics for the agent when presented with a specific type of advertisement. For example, it can be determined that an agent is more likely to effect an advertisement-driven (e.g., respond to a survey, follow a link to a beta release of a website, buy a merchandise) action when the presented advertisement contains age-appropriate music or sound indicia rather than when the advertisement is solely based on imagery. As another example, it can be measured that an agent responds more favorably to advertisement instantiation when cinema, television, or music stars appear on the delivered advertisement endorsing a product or service. As yet another example, typically at check out, a cashier at a supermarket issues paper coupons for specific merchants based on the purchased goods, while for a segment of customers paper coupons are useful for a disparate segment, e.g., early adopters, a soft version of the coupon can increase likelihood of coupon redemption; accordingly, in an aspect of the subject innovation, an information collection component can gather information via a set of cameras and microphones deployed at the cashier and an analysis component can identify the customer with a specific customer segment, subsequently a coupon format optimized for the customer segment is delivered; e.g., an indication to print a coupon is conveyed to the cashier or a coupon is wirelessly conveyed to customer's smart phone. It should be appreciate that compensation, or related advertisement, adaptation provides at least two advantages with respect to conventional “one format fits all” couponing systems: (a) increases likelihood of a posteriori engagement as a result of customized delivered compensation, and (b) magnitude of the coupon can be adjusted contextually in an agent-centric manner, rather than determined based on purchase-centric metrics, e.g., number of specific purchased items.

It is to be appreciated that optimization component 515 can autonomously generate new advertisement content leveraging off existing content in ad content store 535. Generation of new ad content can be driven by analysis provided by ad response analysis component. In an aspect, generation of digital ad content can exploit metadata adaptation of existing content or edition (e.g., addition of a soundtrack, icons, images, etc.) of such content. In another aspect, functionality provided by optimization component 515 can be made available to advertisers on a fee-basis or it can be provided to selected advertisers based on various factors, such as for example time of adoption of, or registration in, subsidized-compensation program, longevity of advertiser's commercial relationship with service platform 430, contracted volume of advertisement, advertiser's market segment (e.g., luxury goods, health services, legal services, food industry, academic products, brand advertiser) and so on.

Advertisement management component 455 also includes an ad display component 545 that presents an agent 410 with intent-compensation incentive advertisement. Advertisement conveyed through ad display component 545 can be rendered at stationary offline points or on substantially any device 112₁-112_{N} registered by agent 410. Displayed advertisements can present a compensation flag (e.g., 548_{K}) or an exact-rebate-value (e.g., 548_{J}) flag. It is to be appreciated that rebated value can be adapted to specific characteristic of agent 410 to which the advertisement is presented. Advertisements can be conveyed in multiple formats (e.g., image-based (e.g., banners), text-based, sound-based, or a combination thereof) depending on the media resources available to the device (e.g., device 112_{N}) in which the advertisement is rendered, or available to an advertisement “dock” (e.g., an outdoor electronic banner) for display of intent-compensation advertisements offline. In one embodiment, ad display component 545 can be employed to notify agent 410 of advertised compensation after agent 410 is no longer utilizing service platform 430. In such embodiment, ad display component 545 can communicate advertisements that were previously presented to agent 110 to substantially any of the devices 112₁-112_{N}. Such embodiment adds value for the service platform and the advertiser as it increases the lock-in of the user with the service platform 430 by increasing the likelihood of repeat engagements, in which new advertisements can be presented to agent 410.

In instances in which compensation relies on an advertisement-driven action that allows an agent 410 to effect the action during a specific period of time, antifraud component 275 can generate a uniquely linked (e.g., via an N-bit (N a positive integer) key ) token pair to identify agent 410 and the action requested by an advertiser associated with the compensation. The token pair facilitates recognizing agent 410 once the ad-driven action is effected and delivering the ensuing compensation (e.g., compensation 165). It should be appreciated that compensation component can convey agent's identification via communication link 418. A record of the notification, and the associated token pair, can be retained in record(s) store 555 or in agent intelligence memory (not shown).

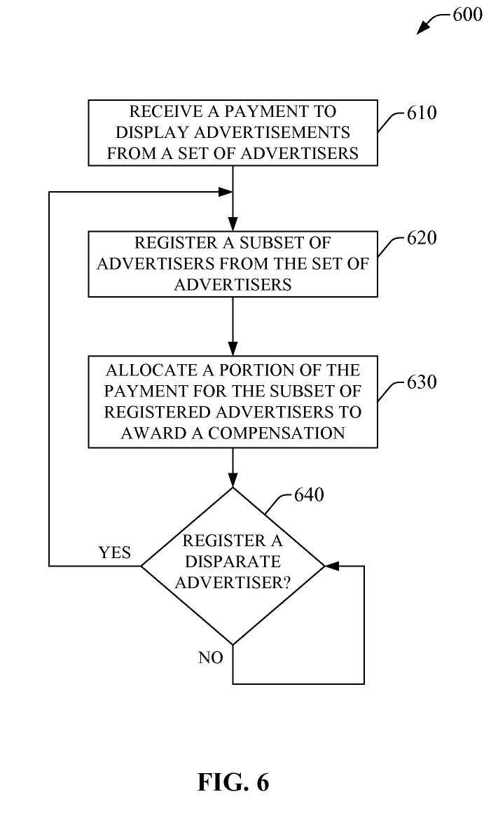

In view of the example systems, and associated aspects, presented and described above, methodologies for funding software through advertisement in exchange for an agent's intent that may be implemented in accordance with the disclosed subject matter can be better appreciated with reference to the flowcharts of FIGS. 6-9. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 6 illustrates an example method 600 for driving advertiser early adoption and retention in accordance with aspects disclosed herein. At act 610 a payment to display advertisement is received. The payment generally arises from various advertisers which can be product, brand, or advocacy advertisers. In an aspect, a service platform (e.g., service platform 110) that operates either online or offline, or both, receives the advertisement payment. Advertisement can be displayed online or offline and the service platform can provide various functionalities to enhance performance of advertisement campaigns. At act 620 an advertiser is registered. Registration is typically managed by a service platform (e.g., service platform 110) and is directed towards providing the registered advertiser with subsidies for compensating customers of the service platform. Subsidies are distributed at act 630, wherein a portion of the payment to display advertisement is allocated to the registered user to deliver a compensation. Typically the portion of the payment arises from advertisement revenue and is a subsidy provided by the service platform that facilitates advertisement campaigns. In an aspect, allocation of compensation funds is directed to a compensation account (e.g., compensation account 145) for the exclusive utilization of the registered advertiser. In an aspect, the registered advertiser delivers compensation is through various responses to advertisement(s). At act 640 it is probed whether a new advertiser is to be registered. In an aspect, a service provider (e.g., service platform 110) can advertise a plan or program that offers the specific distribution of funds for advertiser rebates as described in the subject innovation; thus, probing whether to a new advertiser is to be registered includes processing responses from advertisers that were contacted (e.g., via direct mail) regarding the “Gold Rush” plan. In another aspect, probing whether an advertiser is to be registered can include assessing responses from advertiser(s) to service provider's proposals for partnering to implement or participate in “Gold Rush.” Registration of additional advertisers can be a response to available subsidies for compensation that are allocated to registered advertisers for delivering compensation to a consumer. Registration of additional advertisers driven by the subsidies can ensure early adoption of service platform as a venue for advertising. Compensation subsidies also facilitate advertiser retention.

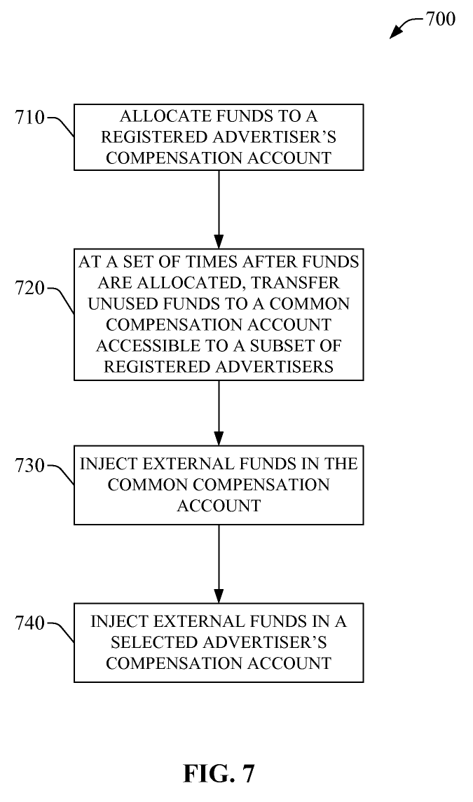

FIG. 7 is a flowchart of an example method 700 for allocating compensation funds according to aspects described herein. At act 710 funds are allocated to a registered advertiser's compensation account. Funds are typically a fraction of a percentage of advertisement revenue collected by a service platform (e.g., service platform 110). Moreover, the percentage is contingent on number of registered advertisers that receive subsidies to compensate consumer. Thus, early adopters generally receive a larger level of funding in view of the smaller number of registered advertisers. Furthermore, it is to be appreciated that fund allocation promotes a “group for the elite” behavior in that advertisement revenue is determined by a universe of advertisers (the “group”), whereas compensation funds are provided to the subgroup (the “elite”) of advertisers that registers to receive subsidies for compensation. At act 720, at a set of times {τ} has elapsed since fund allocation (act 710), a fraction φ=p/q, (wherein q are the net unused funds and p is a portion thereof, in an aspect, p can equal q) of unused compensation funds are transferred to a compensation account (e.g., common account 155) that is common to a set of registered users. In an aspect, the set of times {τ} are dictated by a policy establisghed by the service platform that implements advertisement campaigns, and it can be utilized to regulate the dynamics of advertiser engagement.

At act 730 external funds are injected into the common compensation account. In an aspect fund injection can be utilized as an excitation to the system in order to promote specific patterns of behaviors of advertisers enrolled in subsidized compensation; e.g., registered advertisers are driven through disparate Nash equilibria. In addition, external funds can be exploited as a marketing strategy by specific registered advertisers who seek to boost specific compensation areas (e.g., luxury goods, sweepstakes, . . . ). For example, injected funds can be directed to compensation capped at a specific level, thus being more appropriate for specific market segments and associated advertisers, or merchants or service providers. As another example, injected funds can be time dependent, e.g., funds can be periodically injected to boost adoption, or mitigate attrition. At act 740, external funds can be injected in selected advertiser's accounts. Such fund injection can be driven by the selected advertiser behavior; e.g., advertiser refers peers into system, contracts specific volume of advertisement, requests a grant to explore alternative advertisement technologies or media, and so on. With respect to external fund injection, it is to be noted that either a service platform or an advertiser, or both, can utilize various mechanism to determine a specific time for fund injection, and a particular level of injected funding. Such determinations can be inferential, e.g., generated automatically via artificial intelligence (for example, assisted by an intelligent component like 225)

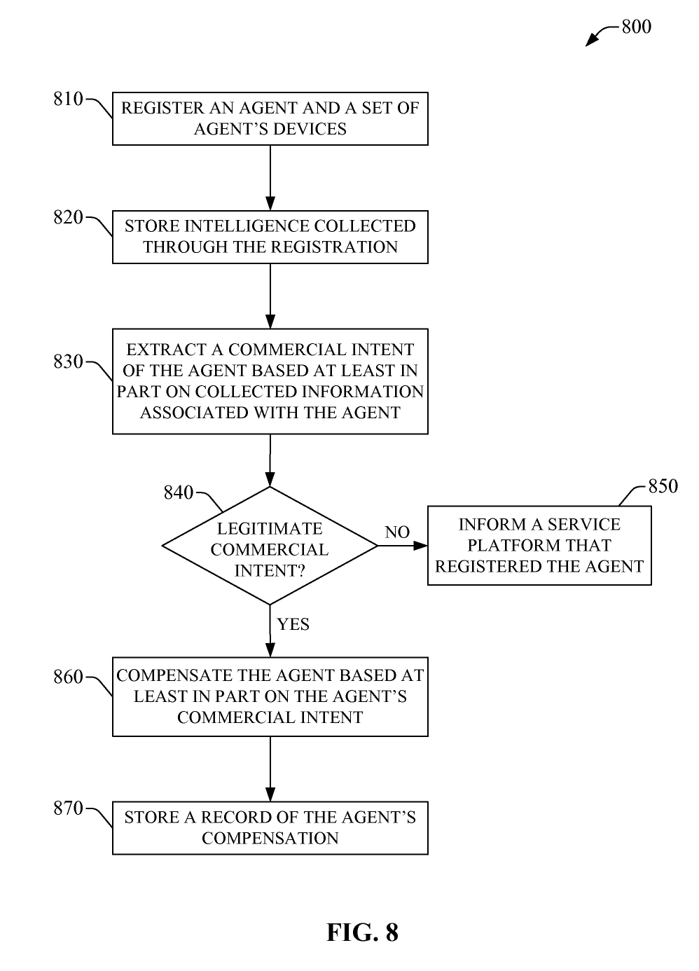

FIG. 8 illustrates an example method 800 for compensating an agent in exchange of the agent's commercial intent. Generally, compensation is provided by a service platform that provides a service or merchandises a product. Service(s) or product(s) can be delivered online or offline. Similarly, agent's intent can be conveyed online or offline, gleaned from implicit or explicit expressions or actions. (FIG. 2 summarizes intent-compensation realizations.) At act 810, an agent and a set of devices that belong to the agent are registered. Typically registration is with a service platform with which the agent intends to conduct a commercial transaction. At act 820, information provided by the agent, or agent intelligence, is stored. Such information can facilitate intent determination, in particular in situations in which agent's intent is inferred through collection of implicit expressions of intent (e.g., standing in line in a movie theater, or waiting in the lobby of a restaurant, parking outside a supermarket store, etc.) At act 830, a commercial intent of the agent is extracted based at least in part on collected information associated with the agent. At act 840, the veracity of legitimacy of the agent's commercial intent is validated. When the validation act indicates intent is fraudulent, a service platform that has registered the agent is informed. Generally, the information can be utilized to flag the agent and collect further information associated with illicit intent, or in order to penalize the agent in future engagements with the service platform. Legitimate intent results in agent's compensation based at least in part on the agent's intent. At act 870, a record of the compensation is stored. The compensation record increases intelligence accumulated on the user, facilitates auditing claims associated with missed compensation, etc.

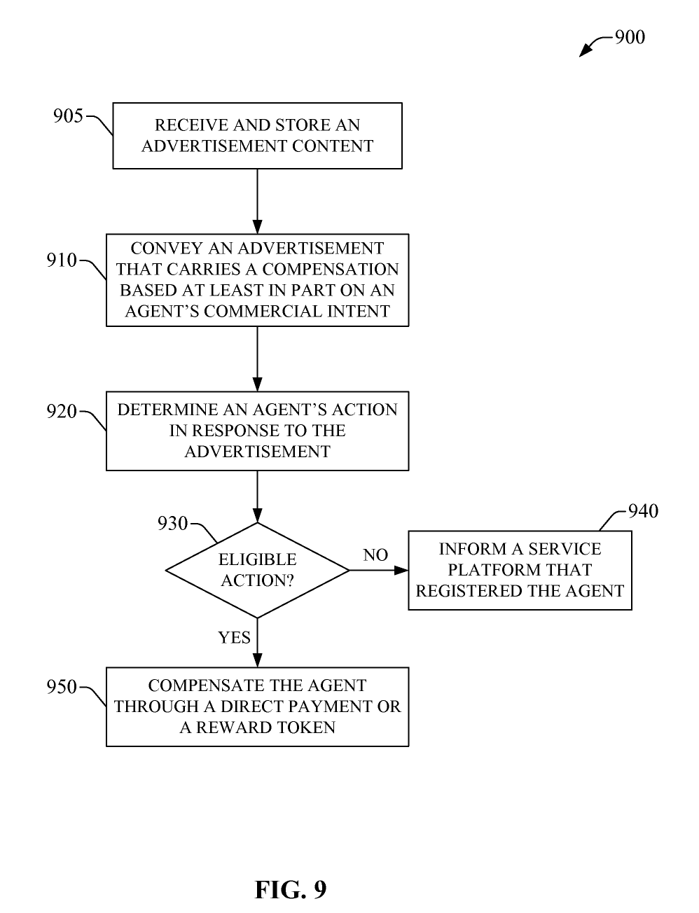

FIG. 9 presents a flowchart of an example method for compensating an agent through advertisement in exchange of agent's intent in transacting with a service platform. At act 910, an advertisement that carries compensation (e.g., Ad J 445_{J} or Ad K 445_{K}) is conveyed, wherein the compensation is based at least in part on an agent's commercial intent. In an aspect, compensation is funded through advertisement spend originated by an advertisement engine (e.g., ad engine 180). The advertisement engine can be a part of a service platform with which the agent interacts commercially, can be a conglomerate of advertisers managed by an advertisement agency that manages and maintains the advertisement engine, or it can be a portion of a content, product or service provider affiliated with the service platform. It should be appreciated that either the advertisement agency or the affiliated provider can run business operations exclusively offline or exclusively online. Alternatively, or in addition, advertisers can be associated with online business operations. It is to be appreciated that regardless the nature of the business operations in connection with the advertisement engine, an advertisement management component can administer advertisement online or offline.

At act 920, an agent's action is determined in response to the conveyed advertisement. The advertisement can indicate the agent that an action is required in order to receive a compensation (e.g., advertisement-driven-action-to-compensation model). Alternatively, compensation can be delivered through advertisement exposure or advertisement instantiation (e.g., the agent opens a link to the advertisement, opens a message carrying the advertisement, received a call for a “sales pitch” advertisement, . . . ).

At act 930, the action is checked in order to determine whether the agent has engaged according to the advertisement model (e.g., exposure, instantiation, action) for compensation. When the agent fails to act accordingly, a service platform that registered the agent is informed at act 940. In an aspect, receiving such information provides the service platform to adjust or optimize advertisement content or delivery in order to promote agent lock-in with the action proposed in the advertisement. At act 950, an agent that performs an eligible action is compensated through either a direct payment (e.g., deposit in a bank account, retirement account, college savings account, credit card account, brokerage account, college/school/childcare tuition account, and so on), or via a reward token like reward points or point currency, digital goods or content, coupons for offline or online stores, and the like.

It is to be appreciated that the methodologies described herein can be employed for, or applied to, substantially any source(s) of funding (e.g., sources 78₁-78_{V} and 81₁-81_{V}) other than advertisers, and to substantially any award program other than a consumer rebate program.

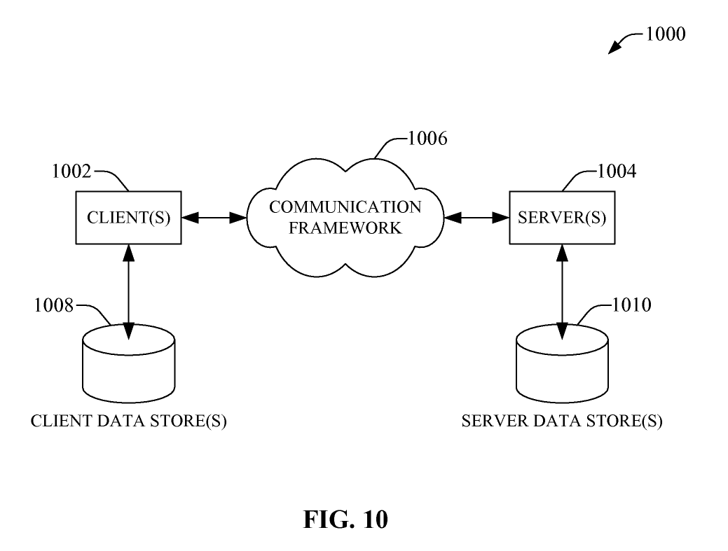

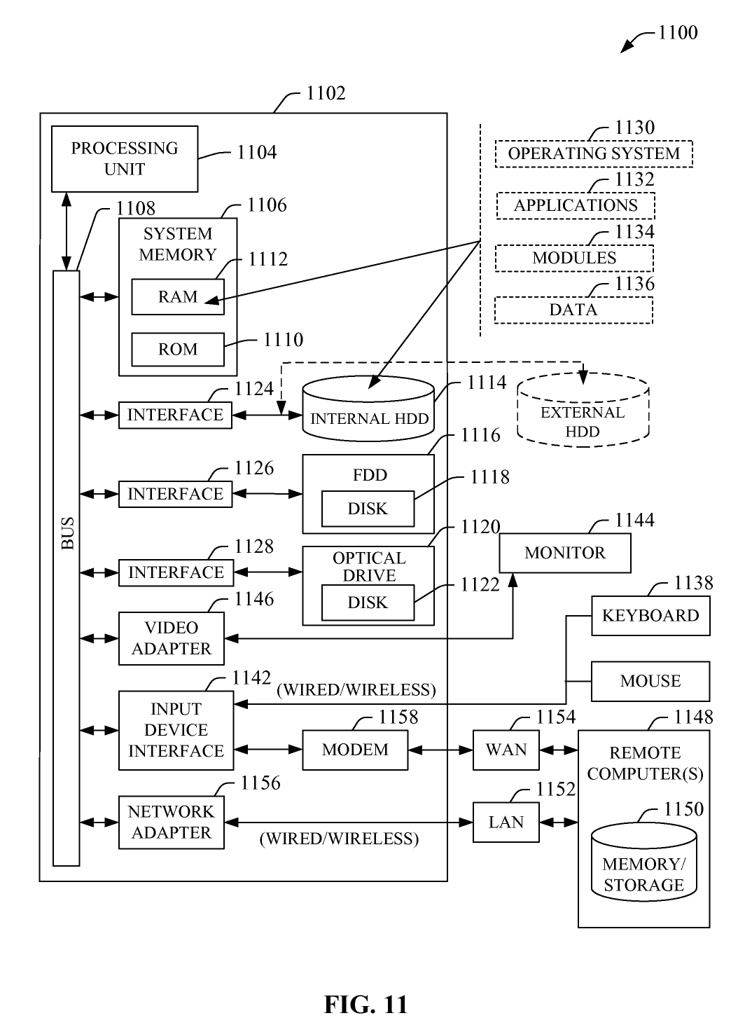

In order to provide additional context for various aspects of the subject specification, FIGS. 10 and 11 and the following discussions are intended to provide a brief, general description of suitable computing environments 1000 and 1100 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

FIG. 10 illustrates a schematic block diagram of a computing environment in accordance with the subject specification. The system 1000 includes one or more client(s) 1002. The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware and/or software (e.g., threads, processes, computing devices). The servers 1004 can house threads to perform transformations by employing the specification, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In FIG. 11, the example environment 1100 for implementing various aspects of the specification includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the specification can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 408 via an interface, such as a video adapter 1146. In addition to the monitor 444, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are example and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “has,” “possesses,” and the like are used in either the detailed description or the claims, such term is intended to be inclusive in a manner similar to the term “comprising” as “comprising” is interpreted when employed as a transitional word in a claim.

What is claimed is:

1. A system to drive early adoption and retention of advertisers in a consumer compensation scheme funded via advertisement, the system comprising:
a component that collects advertising revenue originated from a set of advertisers;
a component that enrolls a subset of advertisers from the set of advertisers;
a component that allocates a portion of the advertisement revenue for the subset of registered advertisers to award a rebate.

2. The system of claim 1, wherein the component that allocates a portion of the advertisement revenue allocates funds to compensation account of a registered advertiser.

3. The system of claim 1, wherein the component that allocates a portion of the advertisement revenue, at a predetermined time, transfers unused allocated funds to a common compensation account accessible to the subset of registered advertisers.

4. The system of claim 1, further comprising a component that injects external funds in the common compensation account.

5. The system of claim 1, wherein the injection component injects external funds in a selected advertiser's compensation account.

6. The system of claim 1, further comprising a storage component that retains intelligence on a registered advertiser.

7. The system of claim 1, wherein the intelligence on the registered advertiser is compatible with a privacy profile determined through a privacy component.

8. The system of claim 1, further comprising a compensation component that awards a compensation, the component including:
a component that accounts awarded compensation;
an antifraud component that mitigates fraudulent compensation; and
a component that retains compensation records.

9. The system of claim 1, further comprising:
a component that registers an agent and a set of devices operated by the agent;
a component that extracts intent from received information associated with the registered agent; the information received at least in one of an offline domain or an online domain;
a component that compensates the agent via advertisement spend in return for the extracted agent's intent.

10. The system of claim 1, further comprising an advertisement management component includes:
an advertisement content store that retains advertisement content;
a component that optimizes an advertisement's content in accordance with the intelligence stored on the registered agent;
a component that optimizes an advertisement's format in accordance with at least one device in the set of registered devices; and
a component that analyzes a registered agent's response to an optimized advertisement.

11. A method for driving early adoption and retention of advertisers in a consumer compensation scheme subsidized through advertisement revenue, the method comprising:
receiving a payment to display advertisements from a set of advertisers;
registering a subset of advertisers from the set of advertisers that paid to display advertisement; and
allocating a portion of the payment for the subset of registered advertisers to award a compensation.

12. The method of claim 11, further comprising:
probing whether a disparate advertiser is to be registered; and
registering the disparate advertiser.

13. The method of claim 11, wherein allocating a portion of the payment for the subset of registered advertisers to award a compensation includes:
allocating funds to compensation account of a registered advertiser; and
transferring a fraction unused allocated funds to a common compensation account accessible to the subset of registered advertisers, wherein the transferring occurs at a set of times after allocating the funds.

14. The method of claim 13 further comprising allocating the funds in the common compensation account according to one of a policy or a market mechanism.

15. The method of claim 13, further comprising injecting external funds in the common compensation account.

16. The method of claim 13, further comprising injecting external funds in a selected advertiser's compensation account.

17. The method of claim 12, further comprising act for intent-based compensation of an agent in exchange for the agent's intent in transacting with a service platform, the acts including:
registering an agent;
extracting a commercial intent of the registered agent through at least one of a set of offline expressions or a set of online expressions;
assessing the legitimacy of the extracted commercial intent;
compensating the registered agent in exchange for the agent's legitimate commercial intent.

18. The method of claim 17, compensating the registered agent in exchange for the agent's legitimate commercial intent further comprising:
conveying an advertisement that carries a compensation based at least in part on the agent's commercial intent;
determining an agent's action in response to the advertisement;
determining the agent's action is an eligible action based at least in part on the advertisement's content; and
compensating the agent through at least one of a direct payment or a reward token.

19. The method of claim 18, conveying an advertisement that carries a compensation based at least in part on the agent's commercial intent further comprising:
receiving a payment to display the advertisement;
allocating a portion of the payment to compensate an agent based at least in part on an agent's commercial intent; and
delivering an advertisement associated with the agent's commercial intent.

20. A computer-readable medium having code instructions stored thereon that, when executed by a computer, cause the computer to perform the following acts:
receiving funds from a universe of sources of funding, wherein the funding is tradable among sources of funding;
enrolling a portion of the universe of sources of funding to participate in an award program;
allocating a portion of received funds to the enrolled sources of funding to issue awards within the award program.
